(19) United States
(12) Patent Application Publication
(10) Pub. No.: US 2024/0287268 A1
(43) Pub. Date: Aug. 29, 2024

(54) RESIN FILM

(71) Applicant: Murata Manufacturing Co., Ltd., Nagaokakyo-shi (JP)

(72) Inventors: Takashi ARAKI, Nagaokakyo-shi (JP); Ryosuke TAKADA, Nagaokakyo-shi (JP); Katsuyuki YOUFU, Nagaokakyo-shi (JP); Masashi UEBE, Nagaokakyo-shi (JP); Masahiro KUBOTA, Nagaokakyo-shi (JP); Shun SAKAIDA, Nagaokakyo-Shi (JP)

(21) Appl. No.: 18/651,238

(22) Filed: Apr. 30, 2024

Related U.S. Application Data
(63) Continuation of application No. PCT/JP2023/008825, filed on Mar. 8, 2023.

(30) Foreign Application Priority Data
Apr. 18, 2022 (JP) 2022-068485

(51) Int. Cl. C08J 5/18; C08K 3/02; C08K 5/29; C08K 9/04

(52) U.S. Cl. CPC C08J 5/18; C08K 3/02; C08K 5/29; C08K 9/04; C08J 2365/00; C08K 2003/026

(57) ABSTRACT

A resin film that is made of a resin composition containing: a resin component; and a covalent organic framework in which a plurality of linker portions and a plurality of multi-site core portions are connected through covalent bonds. In a preferred configuration, the resin component is a thermoplastic resin, the resin composition has a water absorption rate of 0.1 mass % or less, the resin composition has a melting point of higher than 300° C., the resin composition has a relative permittivity of less than 3.0, and the resin composition has a dielectric loss tangent of less than 0.002.

### CROSS REFERENCE TO RELATED APPLICATIONS

The present application is a continuation of International application No. PCT/JP2023/008825, filed Mar. 8, 2023, which claims priority to Japanese Patent Application No. 2022-068485, filed Apr. 18, 2022, the entire contents of each of which are incorporated herein by reference.

### TECHNICAL FIELD

The present disclosure relates to a resin film.

### BACKGROUND ART

In recent years, high-end model information communication devices capable of performing information communication using a high frequency band using 5G have been commercialized. A multilayer substrate mounted on such an information communication device is manufactured from, for example, a copper clad laminate (CCL). The CCL includes a resin film. Preferably, a resin composition constituting the resin film has a low dielectric constant and has a low thermal expansion coefficient for reducing warpage of the CCL. In addition, a resin composition having a lower dielectric constant is required from the viewpoint of improving high frequency characteristics for Beyond 5G and 6G, which enable further high-speed and large-capacity communication.

Conventional resin compositions are disclosed in JP 5199569 B2 (Patent Document 1), JP 2020-147677 A (Patent Document 2), JP 4967116 B2 (Patent Document 3), and JP 2007-231144 A (Patent Document 4).

Patent Document 1 discloses a low dielectric resin composition containing a hollow particle composed of a shell and a hollow portion and a thermosetting resin, wherein 98 mass % or more of the entire shell of the hollow particle is formed of silica. Patent Document 2 discloses a resin molded product containing an insulating resin and a hollow particle having a shell layer containing silsesquioxane. Patent Document 3 discloses a multilayer circuit board having an insulating layer that includes a porous insulating layer formed by dispersing a particulate material in a synthetic resin and a non-porous insulating layer. An aerogel is exemplified as the particulate material. Patent Document 4 discloses a resin composition constituting a resin layer of a wiring board, the resin composition containing a low dielectric constant resin and a zeolite.

In addition, conventional resin compositions are disclosed in JP 2019-183005 A (Patent Document 5), WO 2008/081885 A1 (Patent Document 6), JP 2007-154169 A (Patent Document 7), JP 2021-046538 A (Patent Document 8), JP 2003-147166 A (Patent Document 9), JP H07-099646 B2 (Patent Document 10), JP 2008-075079 A (Patent Document 11), and JP 6865687 B2 (Patent Document 12).

### SUMMARY OF THE INVENTION

As described above, in a resin composition constituting a resin film for use in a multilayer substrate, addition of various kinds of filler to a resin component has been proposed from the viewpoint of improving various physical properties. However, there is still room for improvement in a resin composition constituting a resin film that can be suitably used for a multilayer substrate from the viewpoint of decrease in relative permittivity and decrease in thermal expansion coefficient.

The present disclosure has been made in view of the above problems, and an object of the present disclosure is to provide a resin film that can be suitably used for a multilayer substrate.

A resin film of the present disclosure is made of a resin composition containing: a resin component; and a covalent organic framework in which a plurality of linker portions and a plurality of multi-site core portions are connected through covalent bonds.

According to the present disclosure, since the covalent organic framework has a mesh-like molecular skeleton enclosing air, which has a low relative permittivity, a resin component having a relatively high relative permittivity makes it possible for the resin composition to have a relative permittivity lower than that of the resin component. Furthermore, the mesh-like molecular skeleton of the covalent organic framework has a covalent bond, and therefore is rigid. A resin component having a relatively high linear expansion coefficient makes it possible for the resin composition to have a linear expansion coefficient lower than that of the resin component.

The resin film according to the present disclosure can be suitably used for a multilayer substrate.

### BRIEF EXPLANATION OF THE DRAWINGS

FIG. 1 is a perspective view illustrating a resin film according to an embodiment of the present disclosure.

FIG. 2 is a perspective view schematically illustrating the structure of a two-dimensional COF in a covalent organic framework according to an embodiment of the present disclosure.

### DETAILED DESCRIPTION OF THE INVENTION

Hereinafter, an embodiment of the present disclosure will be described. The same or corresponding portions in the drawings are designated by the same reference symbols and the description thereof will not be repeated.

### [Resin Film]

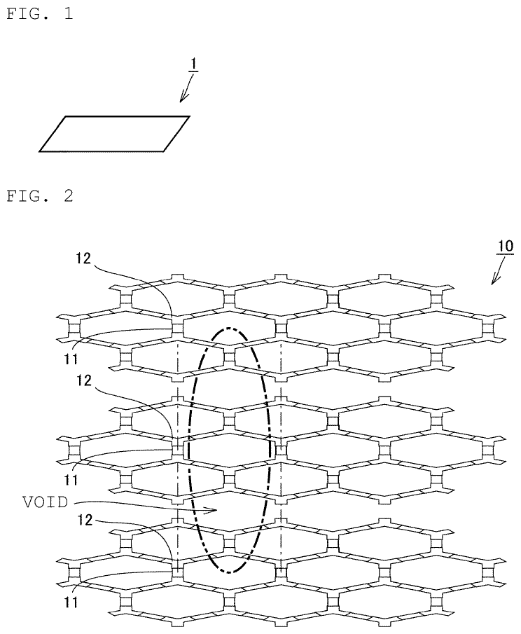

FIG. 1 is a perspective view illustrating a resin film according to an embodiment of the present disclosure. The resin film 1 according to an embodiment of the present disclosure is made of a resin composition containing a resin component and a covalent organic framework, and can be suitably used as a low dielectric layer contained in a multilayer resin substrate (in particular, a circuit board for high frequency) such as a flexible substrate or a rigid substrate. The thickness of the resin film 1 is, for example, 10 μm to 250 μm.

### <Resin Composition>

The resin composition according to the present embodiment preferably has a water absorption rate of 0.1 mass % or less when immersed in water at room temperature for 24 hours. Water has a relatively high dielectric constant. Therefore, when the water absorption rate is 0.1 mass % or less, the resin film made of the resin composition suppresses change in its dielectric constant due to moisture absorption and thereby is more suitably used as a circuit board member for high frequency.

The melting point (Tm) of the resin composition according to the present embodiment is preferably higher than 300° C. When the melting point (Tm) of the resin composition is higher than 300° C., the resin film made of the resin composition has good heat resistance, and therefore can be suitably used for a circuit board for high voltage. The melting point (Tm) of the resin composition is measured based on the measurement of storage elastic modulus (E′) using a dynamic viscoelasticity measuring device. Specifically, the melting point (Tm) of the resin composition is the temperature of the inflection point on the high temperature region side of the storage elastic modulus (E′).

The relative permittivity of the resin composition according to the present embodiment is preferably less than 3.0, more preferably less than 2.8, and still more preferably less than 2.6 when measured by applying a high frequency signal of 30 GHz at an ambient temperature of 25° C. by a cavity resonator method in accordance with JIS R 1641. When the relative permittivity of the resin composition is less than 3.0, the transmission loss in the substrate can be more effectively suppressed when the resin film is used for a high frequency circuit board.

The dielectric loss tangent of the resin composition according to the present embodiment is preferably less than 0.002, and more preferably less than 0.001 when measured by applying a high frequency signal of 30 GHz at an ambient temperature of 25° C. by a cavity resonator method in accordance with JIS R 1641. When the dielectric loss tangent of the resin composition is less than 0.002, the transmission loss in the substrate can be more effectively suppressed when the resin film is used for a high frequency circuit board.

In the resin composition according to the present embodiment, the linear expansion coefficient in the in-plane direction is preferably less than 59 ppm/° C., more preferably 40 ppm/° C. or less, and still more preferably 20 ppm/° C. or less when formed into a film shape. When the linear expansion coefficient is less than 59 ppm/° C., warpage of the circuit board can be effectively suppressed when the circuit board is produced using the resin film made of the resin composition.

### (Resin Component)

Next, the resin component contained in the resin composition will be described. The resin component according to the present embodiment is a thermoplastic resin or a thermosetting resin. When the resin component is a thermoplastic resin, the resin film can be suitably used for a flexible substrate. In addition, the resin component is appropriately selected from the viewpoint of electrical characteristics such as a low relative permittivity or a low dielectric loss tangent, the viewpoint of low water absorption, or the viewpoint of heat resistance. Therefore, examples of the thermoplastic resin include a cyclic olefin-based resin, a chain olefin-based resin, a fluorine-based resin, a styrene-based resin, and a liquid crystal polymer. When the resin component is a thermosetting resin, the resin film can be suitably used for a rigid substrate. Examples of the thermosetting resin include a polyimide.

Examples of the cyclic olefin-based polymer include an addition polymer of a cyclic olefin-based monomer and a ring-opened polymer of a cyclic olefin-based monomer.

Examples of the addition polymer of a cyclic olefin-based monomer include an addition (co) polymer of a norbornene type monomer obtained by polymerizing a norbornene type monomer, and an addition copolymer of a norbornene type monomer and other monomers such as ethylene, an α-olefin, or an unconjugated diene. These addition polymers of a cyclic olefin-based monomer can be obtained by a known polymerization method. Examples of the addition polymer of a commercially available cyclic olefin-based resin include “TOPAS (registered trademark)” (manufactured by Ticona) and “APEL (registered trademark)” (manufactured by Mitsui Chemicals, Inc.), which are addition copolymers of norbornene and ethylene.

The addition polymer of a cyclic olefin-based monomer is preferably an addition polymer of a norbornene monomer (Hereinafter, it may be simply referred to as “polynorbornene”.) obtained by addition polymerization of a norbornene type monomer. The polynorbornene has relatively low water absorption, high heat resistance, and a low dielectric constant. Therefore, by using the polynorbornene as the resin component, a resin film having low water absorption, high heat resistance, and a low dielectric constant can be obtained.

Examples of the addition polymer of a norbornene type monomer include those containing a repeating structure represented by the following general formula (1):

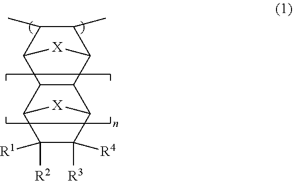

wherein, in the formula (1), X represents —CH₂—, —CH₂CH₂—, or —O—; and R¹, R², R³, and R⁴ each independently represent a hydrogen atom, a hydrocarbon group, a polar group having 1 to 12 carbon atoms, or an organic group containing the polar group; “n” represents an integer of 0 to 2, and the repetition may be different.

It is preferable that at least one of R¹, R², R³, and R⁴ is a cyclic ether group having 1 to 12 carbon atoms, an organic group having a reactive double bond, or a group containing an alkoxysilyl group.

Examples of the polar group having 1 to 12 carbon atoms include a hydroxyl group, a carboxyl group, an ester group, an acryloyl group, a methacryloyl group, a silyl group, an epoxy group, a ketone group, and an ether group. Specific examples of the silyl group include alkoxysilyl groups such as a trimethoxysilyl group and a triethoxysilyl group.

Examples of the organic group containing the polar group having 1 to 12 carbon atoms include those in which the polar group is bonded on a norbornene skeleton through a linear or branched alkyl group, an alkenyl group, an alkynyl group, an aralkyl group, a cyclic aliphatic group, an aryl group, an ether group, or a ketone group. Specific examples of the alkyl group include a methyl group, an ethyl group, a propyl group, an isopropyl group, a butyl group, a pentyl group, a hexyl group, a heptyl group, an octyl group, a nonyl group, a decyl group, and a dodecyl group; specific examples of the alkenyl group include a vinyl group, an allyl group, a butynyl group, and a cyclohexenyl group; specific examples of the alkynyl group include an ethynyl group, a 1-propynyl group, a 2-propynyl group, a 1-butynyl group, a 2-butynyl group; specific examples of the aralkyl group include a benzyl group and a phenethyl group; specific examples of the cyclic aliphatic group include a cyclopentyl group, a cyclohexyl group, and a cyclooctyl group; and specific examples of the aryl group include a phenyl group, a naphthyl group, and an anthracenyl group.

Specific examples of the organic group containing the polar group having 1 to 12 carbon atoms include an organic group containing a silyl group and an organic group containing an epoxy group. Specific examples of the organic group containing a silyl group include a diphenylmethylsilyl group, a triethoxysilylethyl group, a trimethoxysilylpropyl group, and a trimethylsilylmethyl ether group, and specific examples of the organic group containing an epoxy group include a thyl glycidyl ether group and an allyl glycidyl-ether group. However, the polynorbornene in the present disclosure is by no means limited thereto.

As the norbornene type monomer used for producing the addition polymer (polynorbornene) of a norbornene type monomer, a norbornene type monomer represented by the following general formula (2), including 2-norbornene, is preferable:

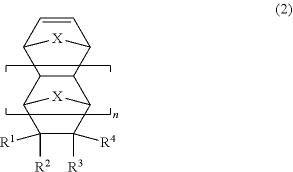

wherein, in the formula (2), X represents —CH₂—, —CH₂CH₂—, or —O—; and R¹, R², R³, and R⁴ each independently represent a hydrogen atom, a hydrocarbon group, a polar group having 1 to 12 carbon atoms, or an organic group containing the polar group; “n” represents an integer of 0 to 2, and the repetition may be different.

Examples of the norbornene type monomer having an alkyl group include 5-methyl-2-norbornene, 5-ethyl-2-norbornene, 5-propyl-2-norbornene, 5-butyl-2-norbornene, 5-pentyl-2-norbornene, 5-hexyl-2-norbornene, 5-heptyl-2-norbornene, 5-octyl-2-norbornene, 5-nonyl-2-norbornene, and 5-decyl-2-norbornene.

Examples of the norbornene type monomer having an alkenyl group include 5-allyl-2-norbornene, 5-methylidene-2-norbornene, 5-ethylidene-2-norbornene, 5-isopropylidene-2-norbornene, 5-(2-propenyl)-2-norbornene, 5-(3-butenyl)-2-norbornene, 5-(1-methyl-2-propenyl)-2-norbornene, 5-(4-pentenyl)-2-norbornene, 5-(1-methyl-3-butenyl)-2-norbornene, 5-(5-hexenyl)-2-norbornene, 5-(1-methyl-4-pentenyl)-2-norbornene, 5-(2,3-dimethyl-3-butenyl)-2-norbornene, 5-(2-ethyl-3-butenyl)-2-norbornene, 5-(3,4-dimethyl-4-pentenyl)-2-norbornene, 5-(7-octenyl)-2-norbornene, 5-(2-methyl-6-heptenyl)-2-norbornene, 5-(1,2-dimethyl-5-hexenyl)-2-norbornene, 5-(5-ethyl-5-hexenyl)-2-norbornene, 5-(1, 2, 3-trimethyl-4-pentenyl)-2-norbornene, and the like.

Examples of the norbornene type monomer having an alkynyl group include 5-ethynyl-2-norbornene.

Examples of the norbornene type monomer having a silyl group include 1,1,3,3,5,5-hexamethyl-1,5-dimethyl bis ((2-(5-norbornene-2-yl) ethyl) trisiloxane.

Examples of the norbornene type monomer having an alkoxysilyl group include dimethyl bis ((5-norbornene-2-yl) methoxy) silane, 5-trimethoxysilyl-2-norbornene, 5-triethoxysilyl-2-norbornene, 5-(2-trimethoxysilylethyl)-2-norbornene, 5-(2-triethoxysilylethyl)-2-norbornene, 5-(3-trimethoxypropyl)-2-norbornene, 5-(4-trimethoxybutyl)-2-norbornene, and 5-trimethylsilylmethyl ether-2-norbornene.

Examples of the norbornene type monomer having an aryl group include 5-phenyl-2-norbornene, 5-naphthyl-2-norbornene, and 5-pentafluorophenyl-2-norbornene, and examples of those having an aralkyl group include 5-benzyl-2-norbornene, 5-phenethyl-2-norbornene, 5-pentafluorophenylmethane-2-norbornene, 5-(2-pentafluorophenylethyl)-2-norbornene, and 5-(3-pentafluorophenylpropyl)-2-norbornene.

Examples of the norbornene type monomer having a hydroxyl group, an ether group, a carboxyl group, an ester group, an acryloyl group, or a methacryloyl group include 5-norbornene-2-methanol and an alkyl ether thereof, acetic acid 5-norbornene-2-methyl ester, propionic acid 5-norbornene-2-methyl ester, butyric acid 5-norbornene-2-methyl ester, valeric acid 5-norbornene-2-methyl ester, caproic acid 5-norbornene-2-methyl ester, caprylic acid 5-norbornene-2-methyl ester, capric acid 5-norbornene-2-methyl ester, lauric acid 5-norbornene-2-methyl ester, stearic acid 5-norbornene-2-methyl ester, oleic acid 5-norbornene-2-methyl ester, linolenic acid 5-norbornene-2-methyl ester, 5-norbornene-2-carboxylic acid, 5-norbornene-2-carboxylic acid methyl ester, 5-norbornene-2-carboxylic acid ethyl ester, 5-norbornene-2-carboxylic acid t-butyl ester, 5-norbornene-2-carboxylic acid i-butyl ester, 5-norbornene-2-carboxylic acid trimethylsilyl ester, 5-norbornene-2-carboxylic acid triethylsilyl ester, 5-norbornene-2-carboxylic acid isobonyl ester, 5-norbornene-2-carboxylic acid 2-hydroxyethyl ester, 5-norbornene-2-methyl-2-carboxylic acid methyl ester, cinnamic acid 5-norbornene-2-methyl ester, 5-norbornene-2-methyl ethyl carbonate, 5-norbornene-2-methyl n-butyl carbonate, 5-norbornene-2-methyl t-butyl carbonate, 5-methoxy-2-norbornene, (meth) acrylic acid 5-norbornene-2-methyl ester, (meth) acrylic acid 5-norbornene-2-ethyl ester, (meth) acrylic acid 5-norbornene-2-n-butyl ester, (meth) acrylic acid 5-norbornene-2-n-propyl ester, (meth) acrylic acid 5-norbornene-2-i-butyl ester, (meth) acrylic acid 5-norbornene-2-i-propyl ester, (meth) acrylic acid 5-norbornene-2-hexyl ester, (meth) acrylic acid 5-norbornene-2-octyl ester, and (meth) acrylic acid 5-norbornene-2-decyl ester.

Examples of the norbornene type monomer having an epoxy group include 5-[(2,3-epoxypropoxy) methyl]-2-norbornene.

Examples of the norbornene type monomer including a tetracyclo ring include 8-methoxycarbonyltetracyclo [4.4.0.1^{2,5}.1^{7,10}] dodec-3-ene, 8-ethoxycarbonyltetracyclo [4.4.0.1^{2,5}.1^{7,10}] dodec-3-ene, 8-n-propylcarbonyltetracyclo [4.4.0.1^{2,5}.1^{7,10}] dodec-3-ene, 8-i-propylcarbonyltetracyclo [4.4.0.1^{2,5}.1^{7,10}] dodec-3-ene, 8-n-butoxycarbonyltetracyclo [4.4.0.1^{2,5}.1^{7,10}] dodec-3-ene, 8-(2-methylpropoxy) carbonyltetracyclo [4.4.0.1^{2,5}.1^{7,10}] dodec-3-ene, 8-(1-methylpropoxy) carbonyltetracyclo [4.4.0.1^{2,5}.1^{7,10}] dodec-3-ene, 8-t-butoxycarbonyltetracyclo [4.4.0.1^{2,5}.1^{7,10}] dodec-3-ene, 8-cyclohexyloxycarbonyltetracyclo [4.4.0.1^{2,5}.1^{7,10}] dodec-3-ene, 8-(4′-t-butylcyclohexyloxy) carbonyltetracyclo [4.4.0.1^{2,5}.1^{7,10}] dodec-3-ene, 8-phenoxycarbonyltetracyclo [4.4.0.1^{2,5}.1^{7,10}] dodec-3-ene, 8-tetrahydrofuranyloxycarbonyltetracyclo [4.4.0.1^{2,5}.1^{7,10}]-3-dodecene, 8-tetrahydropyranyloxycarbonyltetracyclo [4.4.0.1^{2,5}.1^{7,10}] dodec-3-ene, 8-methyl-8-methoxycarbonyltetracyclo [4.4.0.1^{2,5}.1^{7,10}] dodec-3-ene, 8-methyl-8-ethoxycarbonyltetracyclo [4.4.0.1^{2,5}.1^{7,10}] dodec-3-ene, 8-methyl-8-n-propoxycarbonyltetracyclo [4.4.0.1^{2,5}.1^{7,10}] dodec-3-ene, 8-methyl-8-i-propoxycarbonyltetracyclo [4.4.0.1^{2,5}.1^{7,10}] dodec-3-ene, 8-methyl-8-n-butoxycarbonyltetracyclo [4.4.0.1^{2,5}.1^{7,10}] dodec-3-ene, 8-methyl-8-(2-methylpropoxy) carbonyltetracyclo [4.4.0.1^{2,5}.1^{7,10}] dodec-3-ene, 8-methyl-8-(1-methylpropoxy) carbonyltetracyclo [4.4.0.1^{2,5}.1^{7,10}] dodec-3-ene, 8-methyl-8-t-butoxycarbonyltetracyclo [4.4.0.1^{2,5}.1^{7,10}] dodec-3-ene, 8-methyl-8-cyclohexyloxycarbonyltetracyclo [4.4.0.1^{2,5}.1^{7,10}] dodec-3-ene, 8-methyl-8-(4′-t-butylcyclohexyloxy) carbonyltetracyclo [4.4.0.1^{2,5}.1^{7,10}] dodec-3-ene, 8-methyl-8-phenoxycarbonyltetracyclo [4.4.0.1^{2,5}.1^{7,10}] dodec-3-ene, 8-methyl-8-tetrahydrofuranyloxycarbonyltetracyclo [4.4.0.1^{2,5}.1^{7,10}] dodec-3-ene, 8-methyl-8-tetrahydropyranyloxycarbonyltetracyclo [4.4.0.1^{2,5}.1^{7,10}]-3-dodecene, 8-methyl-8-acetoxytetracyclo [4.4.0.1^{2,5}.1^{7,10}] dodec-3-ene, 8,9-di (methoxycarbonyl) tetracyclo [4.4.0.1^{2,5}.1^{7,10}] dodec-3-ene, 8,9-di (ethoxycarbonyl) tetracyclo [4.4.0.1^{2,5}.1^{7,10}] dodec-3-ene, 8,9-di (n-propoxycarbonyl) tetracyclo [4.4.0.1^{2,5}.1^{7,10}] dodec-3-ene, 8,9-di (i-propoxycarbonyl) tetracyclo [4.4.0.1^{2,5}.1^{7,10}] dodec-3-ene, 8,9-di (n-butoxycarbonyl) tetracyclo [4.4.0.1^{2,5}.1^{7,10}] dodec-3-ene, 8,9-di (t-butoxycarbonyl) tetracyclo [4.4.0.1^{2,5}.1^{7,10}] dodec-3-ene, 8,9-di (cyclohexyloxycarbonyl) tetracyclo [4.4.0.1^{2,5}.1^{7,10}] dodec-3-ene, 8,9-di (phenoxyloxycarbonyl) tetracyclo [4.4.0.1^{2,5}.1^{7,10}] dodec-3-ene, 8,9-di (tetrahydrofuranyloxycarbonyl) tetracyclo [4.4.0.1^{2,5}.1^{7,10}]-3-dodecene, 8,9-di (tetrahydropyranyloxycarbonyl) tetracyclo [4.4.0.1^{2,5}.1^{7,10}]-3-dodecene, 8,9-tetracyclo [4.4.0.1^{2,5}.1^{7,10}] dodec-3-ene, tetracyclo [4.4.0.1^{2,5}.1^{7,10}] dodec-3-ene-8-carboxylic acid, 8-methyltetracyclo [4.4.0.1^{2,5}.1^{7,10}] dodec-3-ene-8-carboxylic acid, 8-methyltetracyclo [4.4.0.1^{2,5}.1^{7,10}] dodec-3-ene, 8-ethyltetracyclo [4.4.0.1^{2,5}.1^{7,10}] dodec-3-ene, 8-methyltetracyclo [4.4.0.1^{2,5}. 0^{1,6}] dodec-3-ene, 8-ethylidenetracyclo [4.4.0.1^{2,5}.1^{7,12}] dodec-3-ene, and 8-ethylidenetracyclo [4.4.0.1^{2,5}.1^{7,10}0^{1,6}] dodec-3-ene.

Examples of the ring-opened polymer of a cyclic olefin-based resin include a ring-opened (co) polymer of a norbornene type monomer, a hydrogenated ring-opened (co) polymer of a norbornene type monomer, a ring-opened copolymer of a norbornene type monomer and other monomers such as ethylene, an α-olefin, and an unconjugated diene, or a hydrogenated ring-opened copolymer of a norbornene type monomer and ethylene, an α-olefin, or a norbornene type monomer. The ring-opened polymer of a cyclic olefin-based resin is preferably a hydrogenated ring-opened copolymer of a norbornene type monomer. The hydrogenated ring-opened copolymer of a norbornene type monomer has relatively low water absorption and a low dielectric constant. Therefore, by using a hydrogenated ring-opened copolymer of a norbornene type monomer as the resin component, a resin film having low water absorption and a low dielectric constant is obtained. Examples of the commercially available ring-opened polymer of a cyclic olefin-based resin include “ZEONOR (registered trademark)”, and “ZEONEX (registered trademark)” (manufactured by Zeon Corporation), and “ARTON (registered trademark)” (manufactured by JSR Corporation).

The chain olefin-based resin is an olefin-based resin having no cyclic structure. Examples of the chain olefin-based resin include chain polyolefin-based resins such as a polyethylene-based resin, a polypropylene-based resin, and a polymethylpentene-based resin. These chain polyolefin-based resins may have a linear structure or a branched structure. The chain olefin-based resin is preferably a polymethylpentene-based resin. The polymethylpentene-based resin has a relatively low dielectric constant. Therefore, by using a polymethylpentene-based resin as the resin component, a resin film having a low dielectric constant can be obtained. Examples of the commercially available polymethylpentene-based resin include “TPX (registered trademark)” (manufactured by Mitsui Chemicals, Inc.).

Examples of the fluorine-based resin include polytetrafluoroethylene (PTFE), perfluoroalkoxyalkane (PFA), fluorinated ethylene propylene (FEP), ethylene tetrafluoroethylene copolymer (ETFE), polyvinylidene fluorite (PVDF), polychlorotrifluoroethylene (PCTFE), chloroethylene trifluoroethylene copolymer, and polyvinyl fluoride (PVF). Among them, perfluoroalkoxyalkane is preferable as the fluorine-based resin. Perfluoroalkoxyalkane has relatively low water absorption, high heat resistance, and a low relative permittivity. Therefore, by using perfluoroalkoxyalkane as the resin component, a resin film having low water absorption, high heat resistance, and a low relative permittivity can be obtained. Examples of the commercially available fluorine-based resin include “Fluon (registered trademark) ETFE”, “Fluon (registered trademark) PTFE”, “Fluon (registered trademark) PFA”, and “Fluon+(registered trademark) EA2000” (all manufactured by AGC Inc.).

As the styrene-based resin, syndiotactic polystyrene is preferable. Syndiotactic polystyrene has a relatively low dielectric constant. Therefore, by using syndiotactic polystyrene as the resin component, a resin film having a low dielectric constant can be obtained. Examples of the commercially available syndiotactic polystyrene include “Oidys (registered trademark)” (manufactured by Kurabo Industries Ltd.) and the like.

The liquid crystal polymer is not particularly limited, and examples thereof include a thermotropic liquid crystal polymer. The thermotropic liquid crystal polymer is, for example, an aromatic polyester synthesized mainly from monomers such as an aromatic diol, an aromatic dicarboxylic acid, or an aromatic hydroxycarboxylic acid, and exhibits liquid crystallinity during melting.

The liquid crystal polymer preferably has no amide bond. Examples of the thermotropic liquid crystal polymer having no amide bond include type 1 liquid crystal polymers and type 1.5 (or type 3) liquid crystal polymers. The type 1 liquid crystal polymer is a copolymer of parahydroxybenzoic acid, terephthalic acid, and dihydroxybiphenyl (copolymer of parahydroxybenzoic acid and ethylene terephthalate). The type 1.5 liquid crystal polymer is a copolymer of parahydroxybenzoic acid and 2,6-hydroxynaphthoic acid, and has a melting point between the type 1 liquid crystal polymer and the type 2 liquid crystal polymer. In the present embodiment, the liquid crystal polymer is preferably a type 1.5 liquid crystal polymer. The type 1.5 liquid crystal polymer has relatively low water absorption, high heat resistance, and a low thermal expansion coefficient.

Therefore, by using a type 1.5 liquid crystal polymer as the thermoplastic resin, a resin film having low water absorption, high heat resistance, and a low thermal expansion coefficient can be obtained.

The polyimide is not particularly limited as long as it is a resin having an imide bond in its repeating unit. More specifically, the polyimide is preferably an aromatic polyimide in which an aromatic compound is directly linked through an imide bond. The polyimide has relatively high heat resistance and a low linear expansion coefficient. Therefore, by using a low polyimide as the thermosetting resin, a resin film having high heat resistance and a low thermal expansion coefficient can be obtained. The polyimide is obtained by, for example, heat-treating a polyimide precursor solution. Examples of the commercially available polyimide precursor solution include “U-Imide (registered trademark)” (manufactured by UNITIKA LTD.) and “UPIA (registered trademark)” (manufactured by Ube Industries, Ltd.).

The resin component according to the present embodiment preferably has a water absorption rate of 0.1 mass % or less when immersed in water at room temperature for 24 hours. Water has a relatively high dielectric constant. Therefore, when the water absorption rate of the resin component is 0.1 mass % or less, the water absorption rate of the resin composition according to the present embodiment is also low. As a result, the resin film made of the resin composition suppresses change in its dielectric constant due to moisture adsorption and thereby is more suitably used as a circuit board member for high frequency.

The melting point (Tm) of the resin component according to the present embodiment is preferably higher than 300° C. When the melting point (Tm) of the resin component is higher than 300° C., the melting point (Tm) of the resin composition containing the resin component is also relatively high. Eventually, the resin film made of the resin composition has good heat resistance, and therefore can be suitably used for a circuit board for high voltage. The melting point (Tm) of the resin component is measured based on the measurement of storage elastic modulus (E′) using a dynamic viscoelasticity measuring device. Specifically, the melting point (Tm) of the resin component is the temperature of the inflection point on the high temperature region side of the storage elastic modulus (E′).

The relative permittivity of the resin component according to the present embodiment is preferably less than 3.0, more preferably less than 2.8, and still more preferably less than 2.6 when measured by applying a high frequency signal of 30 GHz at an ambient temperature of 25° C. by a cavity resonator method in accordance with JIS R 1641. When the relative permittivity of the resin component is less than 3.0, the relative permittivity of the resin composition also decreases. As a result, when the resin film according to the present embodiment is used for a high-frequency circuit board, transmission loss in the board can be more effectively suppressed.

The dielectric loss tangent of the resin component according to the present embodiment is preferably less than 0.002, and more preferably less than 0.001 when measured by applying a high frequency signal of 30 GHz at an ambient temperature of 25° C. by a cavity resonator method in accordance with JIS R 1641. A resin composition containing a resin component having a dielectric loss tangent of less than 0.002 has a relatively low dielectric loss tangent. Therefore, when the film made of the resin composition is used for a high frequency circuit board, the transmission loss in the board can be more effectively suppressed.

In the resin component according to the present embodiment, the linear expansion coefficient in the in-plane direction is preferably less than 59 ppm/° C., more preferably 40 ppm/° C. or less, and still more preferably 20 ppm/° C. or less when formed into a film shape. When the linear expansion coefficient is less than 59 ppm/° C., the linear expansion coefficient of the resin composition containing the resin component is also relatively low. Therefore, when a circuit board is produced using a film made of the resin composition, warpage of the circuit board can be effectively suppressed.

### (Covalent Organic Framework)

The covalent organic framework (COF: Covalent Organic Frameworks) contained in the resin composition according to the present embodiment is a porous crystalline particle in which organic structures are covalently bonded to each other to form a periodic structure, and the COF is in a powder form. Specifically, the COF according to the present embodiment is a structure in which a plurality of linker portions and a plurality of multi-site core portions are connected through covalent bonds. As a result, the COF has a mesh-like molecular skeleton in which a large number of pores are formed. The multi-site core portion is an organic structural part located at a branch point of the mesh-like molecular skeleton of the COF, and the linker portion is an organic structural part connecting two multi-site core portions located on both sides of the linker portion.

The type of the covalent bond of the COF may be any of a single bond, a double bond, and a triple bond, and is preferably a double bond from the viewpoint of both ease of synthesis of the COF and improvement of the rigidity of the COF. When the covalent bond of the COF is a double bond, the COF has a more rigid structure, and the resin composition containing the COF as a filler has a lower linear expansion coefficient. The covalent bond of the COF is more preferably a carbon-nitrogen double bond in which a carbon atom (preferably a CH group) and a nitrogen atom are bonded to each other (imine bond). When the double bond between the linker portion and the multi-site core portion of the COF is a carbon-nitrogen double bond (imine bond), the linker portion has a carbon atom (preferably a CH group) constituting the imine bond, and the multi-site core portion has a nitrogen atom constituting the imine bond. Alternatively, the linker portion has a nitrogen atom constituting the imine bond, and the multi-site core portion has a carbon atom (preferably a CH group) constituting the imine bond.

In the present embodiment, the linker portion has a structure in which each of two atoms constituting an imine bond (that is, a nitrogen atom or a carbon atom) is bonded to an aromatic compound, a heterocyclic compound, or a fused heterocyclic compound. The aromatic compound bonded to atoms constituting an imine bond in the linker portion preferably has one or more benzene rings, one or more fused polycyclic aromatic hydrocarbons, one or more heterocyclic aromatic compounds, or one or more fused heterocyclic aromatic compounds. Examples of the linker portion include structures represented by the following chemical formulae (3) to (6).

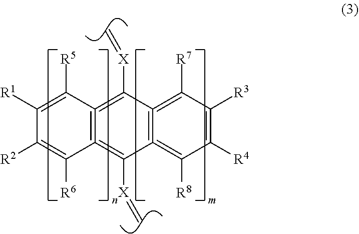

In the formula (3), “n” and “m” are each independently an integer of 0 to 10, R¹ to R⁸ are each independently any of hydrogen, halogen, a hydroxy group, an alkyl group, an alkoxy group, an aryl group, a phosphine group, a phosphine oxide group, or an aromatic heterocyclic group, and X is a CH group or nitrogen.

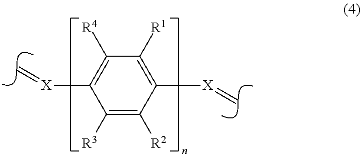

In the formula (4), “n” is an integer of 1 to 10, R¹ to R⁴ are each independently hydrogen, halogen, a hydroxy group, an alkyl group, an alkoxy group, an aryl group, a phosphine group, a phosphine oxide group, or an aromatic heterocyclic group, and X is a CH group or nitrogen.

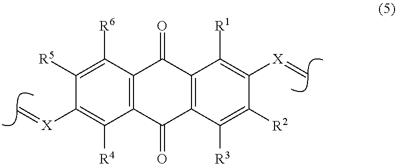

In the formula (5), R¹ to R⁶ each independently represent any of hydrogen, halogen, a hydroxy group, an alkyl group, an alkoxy group, an aryl group, a phosphine group, a phosphine oxide group, and an aromatic heterocyclic group, and X represents a CH group or nitrogen.

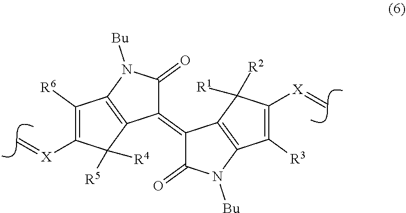

In the formula (6), R¹ to R⁶ each independently represent any of hydrogen, halogen, a hydroxy group, an alkyl group, an alkoxy group, an aryl group, a phosphine group, a phosphine oxide group, and an aromatic heterocyclic group, and X represents a CH group or nitrogen.

In the description of the formulae (3) to (6), the alkyl group may be linear or branched, or may be a cycloalkyl group. The number of carbon atoms in the alkyl group is about 1 to 20. The alkoxy group may be linear or branched, and may be a cycloalkyloxy group. The number of carbon atoms in the alkoxy group is about 1 to 20. The aryl group is an atomic group obtained by removing one hydrogen atom from an aromatic hydrocarbon. The aryl group includes a group having a fused ring, and a group in which two or more independent benzene rings or fused rings are bonded directly or via a group such as vinylene.

In the present embodiment, the multi-site core portion has a structure in which each of three or more atoms constituting an imine bond (that is, a nitrogen atom or a carbon atom) is bonded to an aromatic compound, a heterocyclic compound, or a fused heterocyclic compound. The aromatic compound bonded to the atoms constituting an imine bond in the multi-site core portion preferably has one or more benzene rings, one or more fused polycyclic aromatic hydrocarbons, one or more heterocyclic aromatic compounds, or one or more fused heterocyclic aromatic compounds. Examples of the multi-site core portion include structures represented by the following chemical formulae (7) to (9).

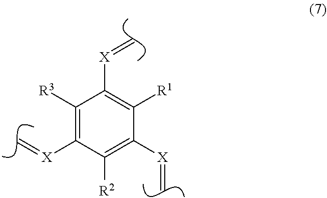

In the formula (7), R¹ to R³ each independently represent any of hydrogen, halogen, a hydroxy group, an alkyl group, an alkoxy group, an aryl group, a phosphine group, a phosphine oxide group, and an aromatic heterocyclic group, and X represents a CH group or nitrogen.

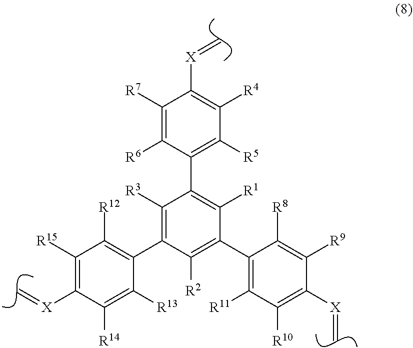

In the formula (8), R¹ to R¹⁵ each independently represent any of hydrogen, halogen, a hydroxy group, an alkyl group, an alkoxy group, an aryl group, a phosphine group, a phosphine oxide group, and an aromatic heterocyclic group, and X represents a CH group or nitrogen.

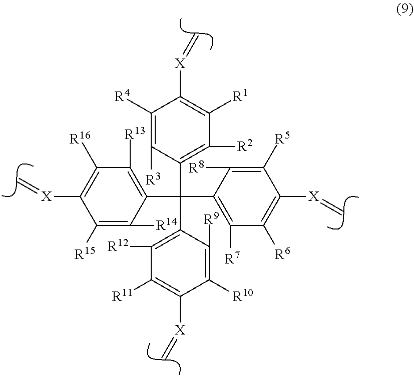

In the formula (9), R¹ to R¹⁶ each independently represent any of hydrogen, halogen, a hydroxy group, an alkyl group, an alkoxy group, an aryl group, a phosphine group, a phosphine oxide group, and an aromatic heterocyclic group, and X represents a CH group or nitrogen.

In the description of the formulae (7) to (9), the alkyl group may be linear or branched, or may be a cycloalkyl group. The number of carbon atoms in the alkyl group is about 1 to 20. The alkoxy group may be linear or branched, and may be a cycloalkyloxy group. The number of carbon atoms in the alkoxy group is about 1 to 20. The aryl group is an atomic group obtained by removing one hydrogen atom from an aromatic hydrocarbon. The aryl group includes a group having a fused ring, and a group in which two or more independent benzene rings or fused rings are bonded directly or via a group such as vinylene.

The linker portion and/or the multi-site core portion preferably have a phosphorus element, and for example, preferably have a phosphine group or a phosphine oxide group. When the linker portion and/or the multi-site core portion has a phosphorus element, the resin composition can be provided with flame retardancy, or the resin composition can be improved in flame retardancy. In addition, the linker portion and/or the multi-site core portion also preferably have an alkyl group from the viewpoint of improving the hydrophobicity of the resin composition.

In the present embodiment, it is preferable that both terminals of the linker portion are carbon atoms and the multi-site core portion has a nitrogen atom, and the covalent bond of the COF is a carbon-nitrogen double bond in which the carbon atom of the linker portion and the nitrogen atom of the multi-site core portion are bonded to each other. In the resin composition obtained by adding such a COF to the resin component, the carbon-nitrogen double bond in which the carbon atom of the linker portion and the nitrogen atom of the multi-site core portion are bonded to each other is rigid, and therefore suppresses increase in the dielectric loss tangent.

When the covalent bond of the COF is a carbon-nitrogen double bond in which the carbon atom of the linker portion and the nitrogen atom of the multi-site core portion are bonded to each other, specifically, the linker portion has two carbon atoms to be bonded to the nitrogen atom of the multi-site core portion, and the multi-site core portion has three or more nitrogen atoms to be bonded to the carbon atom of the linker portion. When the multi-site core portion has three nitrogen atoms to be bonded to the carbon atom of the linker portion, the COF can easily form a skeleton of a so-called two-dimensional COF having a mesh structure spreading in a planar shape. When the multi-site core portion has four nitrogen atoms to be bonded to the carbon atom of the linker portion, the COF can easily form a skeleton of a so-called three-dimensional COF having a sterically spreading mesh structure.

The structure of the two-dimensional COF will be described with reference to a schematic diagram. FIG. 2 is a perspective view schematically illustrating the structure of a two-dimensional COF in the covalent organic framework according to an embodiment of the present disclosure. As shown in FIG. 2, the covalent organic framework (COF) 10 is a structure in which a plurality of linker portions 11 and a plurality of multi-site core portions 12 are connected, and has a mesh-like skeleton. In FIG. 2, since an example of the two-dimensional COF is illustrated as the COF 10, the meshed skeleton spreads in a planar shape. Further, the COF 10 has crystallinity. As illustrated in FIG. 2, the two-dimensional COF 10 has a plurality of mesh skeletons spreading in a planar shape that is arranged along the direction intersecting the plane direction in which the mesh skeleton spreads. Further, a plurality of holes formed by the mesh structures is aligned along the direction in which the plurality of mesh structures are aligned. Therefore, a relatively large void is formed inside the two-dimensional COF 10 by arranging a plurality of holes. Since the two-dimensional COF 10 can hold a relatively large amount of air in this void, the relative permittivity is low. Therefore, when the two-dimensional COF 10 is added to a resin component having a relatively high relative permittivity, a resin composition having a relative permittivity lower than that of the resin component can be obtained.

Specific examples of the COF include structures represented by the following chemical formulae (10) to (12), but the COF is not limited thereto.

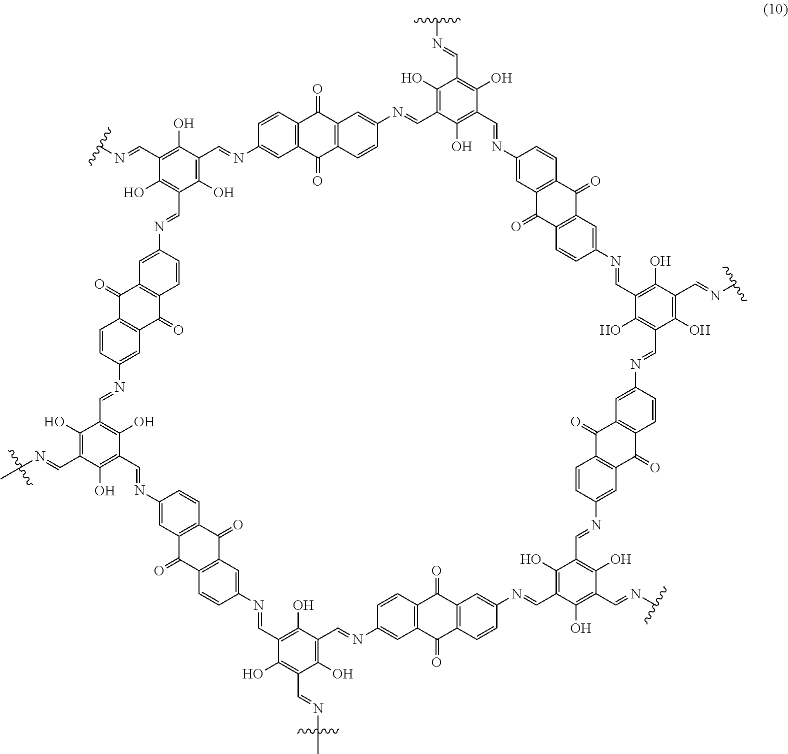 [SMILES: */N=C/c1c(O)c2c(O)c(c1O)/C=N/c1ccc3c(c1)C(=O)c1ccc(cc1C3=O)/N=C/c1c(O)c(/C=N/*)c(O)c(c1O)/C=N/c1ccc3c(c1)C(=O)c1ccc(cc1C3=O)/N=C/c1c(O)c(/C=N/*)c(O)c(c1O)/C=N/c1ccc3c(c1)C(=O)c1ccc(cc1C3=O)/N=C/c1c(O)c(/C=N/*)c(O)c(c1O)/C=N/c1ccc3c(c1)C(=O)c1ccc(cc1C3=O)/N=C/c1c(O)c(/C=N/*)c(O)c(c1O)/C=N/c1ccc3c(c1)C(=O)c1ccc(cc1C3=O)/N=C/c1c(O)c(/C=N/*)c(O)c(c1O)/C=N/c1ccc3c(c1)C(=O)c1ccc(cc1C3=O)/N=C/2]

In the COF represented by the above formula (10), the linker portion has two nitrogen atoms located at both terminals thereof, and the multi-site core portion has three carbon atoms (specifically, CH groups) bonded to the nitrogen atoms located at both terminals of the linker portion. Therefore, the COF represented by the above formula (10) has a so-called two-dimensional COF structure having a mesh structure spreading in a planar shape.

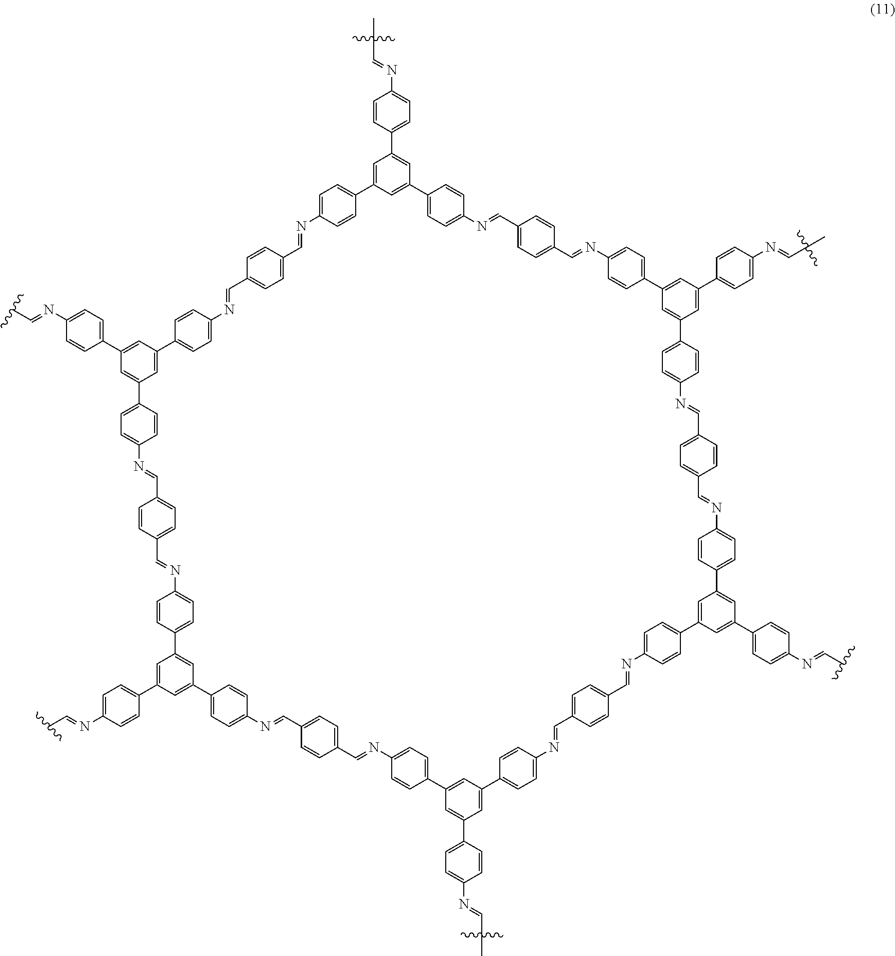 [SMILES: */C=N/c1ccc(-c2cc3cc(c2)c2ccc(cc2)ncc2ccc(cc2)cnc2ccc(cc2)c2cc(-c4ccc(/N=C/*)cc4)cc(c2)c2ccc(cc2)ncc2ccc(cc2)cnc2ccc(cc2)c2cc(-c4ccc(/N=C/*)cc4)cc(c2)c2ccc(cc2)ncc2ccc(cc2)cnc2ccc(cc2)c2cc(-c4ccc(/N=C/*)cc4)cc(c2)c2ccc(cc2)ncc2ccc(cc2)cnc2ccc(cc2)c2cc(-c4ccc(/N=C/*)cc4)cc(c2)c2ccc(cc2)ncc2ccc(cc2)cnc2ccc(cc2)c2cc(-c4ccc(/N=C/*)cc4)cc(c2)c2ccc(cc2)ncc2ccc(cc2)cnc2ccc3cc2)cc1]

In the COF represented by the above formula (11), the linker portion has two carbon atoms (specifically, CH groups) located at both terminals thereof, and the multi-site core portion has three nitrogen atoms bonded to the carbon atoms (specifically, CH groups) at both terminals of the linker portion. Therefore, the COF represented by the above formula (10) has a so-called two-dimensional COF structure having a mesh structure spreading in a planar shape.

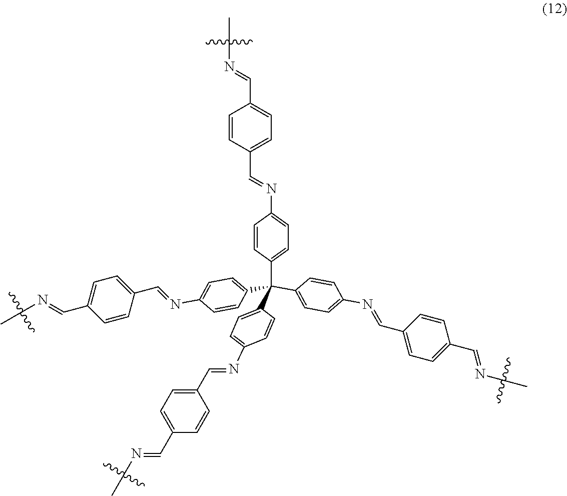

In the COF represented by the above formula (12), the linker portion has two carbon atoms (specifically, CH groups) located at both terminals thereof, and the multi-site core portion has four nitrogen atoms bonded to the carbon atoms (specifically, CH groups) at both terminals of the linker portion. Therefore, the COF represented by the above formula (12) has a so-called three-dimensional COF structure having a sterically spreading mesh structure.

The content ratio of the covalent organic framework is preferably 10 vol % or more, preferably 20 vol % or more, and more preferably 30 vol % or more with respect to the resin composition. When the content ratio of the covalent organic framework is 10 vol % or more with respect to the resin composition, the linear expansion coefficient of the resin composition can be more effectively reduced, and when the content ratio is 30 vol % or more, the resin composition can be provided with flame retardancy when the resin component has relatively low flame retardancy. The upper limit of the content ratio of the covalent organic framework is not particularly limited, but is preferably 80 vol % or less, more preferably 70 vol % or less, and still more preferably 60 vol % or less from the viewpoint that the resin film does not have excessively increased rigidity.

The method for producing the COF is not particularly limited, but when the covalent bond of the COF is a carbon-nitrogen double bond (imine bond), the COF can be obtained by subjecting a compound having a plurality of aldehyde groups and a compound having a plurality of amino groups to a dehydration condensation reaction. That is, a linker compound having aldehyde groups at both terminals and constituting a linker portion of the COF by a dehydration condensation reaction and a multi-site core compound having three or more amino groups and constituting a multi-site core portion of the COF by a dehydration condensation reaction are subjected to a dehydration condensation reaction to obtain a COF having an imine bond. Alternatively, a linker compound having amino groups at both terminals and a multi-site core compound having three or more aldehyde groups are subjected to a dehydration condensation reaction to obtain a COF having an imine bond.

For example, 2,6-diaminoanthraquinone as the linker compound and 2,4,6-triformyl phloroglucinol as the multi-site core compound are subjected to a dehydration condensation reaction to obtain a COF represented by the structure of the above formula (10). In addition, terephthalaldehyde as the linker compound and 1,3,5-tris (4-aminophenyl) benzene as the multi-site core compound are subjected to a dehydration condensation reaction to obtain a COF represented by the structure of the above formula (11). In addition, terephthalaldehyde as the linker compound and tetrakis (4-aminophenyl) methane as the multi-site core compound are subjected to a dehydration condensation reaction to obtain a COF represented by the structure of the above formula (12). The method for producing the COF represented by the structures of the formulae (10) to (12) is not limited to the above methods.

### (Other Additives)

The resin composition according to the present embodiment may contain other additives in addition to the COF for the purpose of improving physical properties such as water absorption, heat resistance, and electrical properties. For example, the resin composition may contain an inorganic filler and an organic filler other than the COF. Examples of the inorganic filler and the organic filler include a hollow silica, a hollow glass, a zeolite, an aerogel, silsesquioxane, and the like. The resin composition according to the present embodiment may contain only the COF as a filler.

### [Method for Producing Resin Film]

The method for producing the resin film is not particularly limited. It is possible that a precursor solution of the resin component is added with the COF to adjust a resin solution, the resin solution is applied to a carrier film or directly applied to another layer of the multilayer substrate, and the applied resin solution is heated and dried to obtain the resin film. Alternatively, it is possible that the heated and melted resin component is added with the COF, the mixture is stirred to obtain a melted resin composition, and thereafter, the resin composition is molded by injection molding, press molding, or the like, to obtain the resin film. In addition, it is possible that a resin composition in which the resin component has been previously added with the COF is prepared, and the resin composition is heated and melted and then is molded by injection molding, press molding, or the like, to obtain the resin film.

### EXAMPLES

Hereinafter, the resin film according to the present disclosure will be described in more detail with reference to Examples, but the present invention is not limited thereto.

### [Preparation of Covalent Organic Framework]

First, three kinds of COFs were prepared before preparing the resin compositions of each Example. The specific methods for producing each COF will be described below.

<COF (a)>

In ultrapure water, 2,6-diaminoanthraquinone (manufactured by Tokyo Chemical Industry Co., Ltd.) (1 mol/L) as a linker compound and 2,4,6-triformyl phloroglucinol (670 mmol/L) as a multi-site core compound were stirred overnight at room temperature in the presence of p-toluenesulfonic acid monohydrate (manufactured by Tokyo Chemical Industry Co., Ltd.) (5 mol/L) as an acid catalyst. Thereafter, the product precipitated in the mixed liquid was recovered by filtration, sufficiently washed with ultrapure water, tetrahydrofuran, and methanol in this order, and dried to obtain “COF (a)” as a covalent organic framework.

<COF (b)>

In a mixed liquid obtained by mixing 1,4-dioxane and mesitylene at a volume ratio of 4:1, terephthalaldehyde (manufactured by Tokyo Chemical Industry Co., Ltd.) (37.5 mmol/L) as a linker compound and 1,3,5-tris (4-aminophenyl) benzene (manufactured by Tokyo Chemical Industry Co., Ltd.) (25 mmol/L) as a multi-site core compound were stirred at room temperature for 1 hour in the presence of Sc (Otf)₃ (manufactured by Tokyo Chemical Industry Co., Ltd.) (1.5 mmol/L) as a Lewis acid catalyst. Thereafter, the product precipitated in the mixed liquid was recovered by filtration and washed with 1,4-dioxane and mesitylene. Thereafter, the resultant was washed with methanol for 15 hours using a Soxhlet extractor and dried to obtain “COF (b)” as a covalent organic framework.

<COF (c)>

In a mixed liquid obtained by mixing 1,4-dioxane and mesitylene at a volume ratio of 4:1, terephthalaldehyde (manufactured by Tokyo Chemical Industry Co., Ltd.) (37.5 mmol/L) as a linker compound and tetrakis (4-aminophenyl) methane (manufactured by Tokyo Chemical Industry Co., Ltd.) (18.8 mmol/L) as a multi-site core compound were stirred at room temperature for 1 hour in the presence of scandium (III) triflate (manufactured by Tokyo Chemical Industry Co., Ltd.) (1.5 mmol/L) as a Lewis acid catalyst. Thereafter, the product precipitated in the mixed liquid was recovered by filtration and washed with 1,4-dioxane and mesitylene.

Thereafter, the resultant was washed with methanol for 15 hours using a Soxhlet extractor and dried to obtain “COF (c)” as a covalent organic framework.

### Example 1

The COF (b) was added to a polyimide precursor solution (trade name: “U-Imide (registered trademark)”, manufactured by UNITIKA LTD.) and stirred to adjust a resin solution. This resin solution was applied to a carrier film (trade name: “Lumirror film (registered trademark)”, manufactured by Toray Industries, Inc.). Thereafter, the carrier film coated with the resin solution was heated and dried to obtain a laminate. The carrier film was removed from the laminate to obtain the resin film of Example 1. In Example 1, the resin solution was adjusted so that the content ratio of the COF (b) was 30 vol % with respect to the entire resin film, and the resin solution was applied onto the carrier film so that the thickness of the dried resin film was 50 μm.

### Example 2

Syndiotactic polystyrene (SPS) (trade name: “Oidys (registered trademark)”, manufactured by Kurabo Industries Ltd.) was melted, and the COF (b) was added to the melted SPS and kneaded to obtain a molten resin composition. The molten resin composition was applied onto a continuous metal belt, cooled, and then peeled off from the continuous belt to obtain the resin film of Example 2. In Example 2, the SPS and the COF (b) were kneaded so that the content ratio of the COF (b) was 30 vol % with respect to the entire resin film, and the molten resin composition was applied onto the continuous metal belt so that the thickness of the resin film was 50 μm.

### Example 3

First, a liquid crystal polymer was prepared. A reactor equipped with a stirrer, a torque meter, a nitrogen gas inlet tube, a thermometer, and a reflux condenser was charged with p-hydroxybenzoic acid (911 g), 4,4′-dihydroxybiphenyl (409 g), terephthalic acid (274 g), isophthalic acid (91 g), and acetic anhydride (1235 g). After the inside of the reactor was sufficiently replaced with nitrogen gas, the temperature was raised to 150° C. over 15 minutes under a nitrogen gas stream, and the temperature was maintained and reflux was performed for 3 hours. Then, while distilling off by-product acetic acid and unreacted acetic anhydride, the temperature was raised to 300° C. over 2 hours and 50 minutes. Then, the time point when an increase in torque was observed was regarded as the end of the reaction, and the contents were taken out into a vat in a molten state to obtain a liquid crystal polyester as a liquid crystal polymer. The obtained liquid crystal polymer was cooled and pulverized with a pulverizer to obtain a liquid crystal polymer powder.

The powdery liquid crystal polymer obtained above was melted and kneaded with the COF (b) using a kneader to obtain a molten resin composition. The molten resin composition was applied onto a continuous metal belt, cooled, and then peeled off from the continuous belt to obtain the resin film of Example 3. In Example 3, the liquid crystal polymer and the COF (b) were kneaded so that the content ratio of the COF (b) was 30 vol % with respect to the entire resin film, and the molten resin composition was applied onto the continuous metal belt so that the thickness of the resin film was 50 μm.

### Example 4

Perfluoroalkoxyalkane (PFA) (trade name: “Fulton+(registered trademark) EA2000”, manufactured by AGC Inc.) was melted, and the COF (b) was added to the melted PFA and kneaded with a kneader to obtain a molten resin composition. The molten resin composition was applied onto a continuous metal belt, cooled, and then peeled off from the continuous belt to obtain the resin film of Example 4. In Example 4, the PFA and the COF (a) were kneaded so that the content ratio of the COF (a) was 10 vol % with respect to the entire resin film, and the molten resin composition was applied onto the carrier film so that the thickness of the resin film was 50 μm.

### Examples 5 to 12

Based on Table 1 shown below, resin films were prepared so that at least one of the type of the covalent organic framework (COF) (COF (a), COF (b), COF (c)) and the content ratio (vol %) of the covalent organic framework (COF) with respect to the entire resin film was different from that in Example 4. The resin films of Examples 5 to 12 were prepared in the same manner as in the resin film of Example 4 except for the type and/or content ratio of the COF.

### Example 13

A ring-opened polymer (COP) of a cyclic olefin-based resin (trade name: “ZEONOR (registered trademark)”, manufactured by Zeon Corporation) was melted, and the COF (b) was added to the melted COP and kneaded with a kneader to obtain a molten resin composition. The molten resin composition was applied onto a continuous metal belt, cooled, and then peeled off from the continuous belt to obtain the resin film of Example 13. In Example 13, the COP and the COF (b) were kneaded so that the content ratio of the COF (b) was 30 vol % with respect to the entire resin film, and the molten resin composition was applied onto a carrier film so that the thickness of the resin film was 50 μm.

### Example 14

First, an addition polymer of a norbornene-based monomer (polynorbornene (PNB)) was prepared. In a reaction vessel in which the polymerization atmosphere was sufficiently filled with an inert gas, nitrogen, 16.4 g (0.07 mol) of 2-norbornene, 5.41 g (0.03 mol) of 5-hexyl-2-norbornene, 130 g of ethyl acetate as a polymerization solvent, and 115 g (0.53 mol) of cyclohexane were charged. Next, a catalyst solution in which 0.69 g (1.4×10⁻³ mol) of a transition metal catalyst (n6-toluene nickel bis (pentafluorophenyl) was dissolved in 5 g of toluene was charged into a reaction vessel. After polymerization at room temperature for 4 hours while stirring, the polymerization solution was added to a mixed solution of 47 ml of glacial acetic acid, 87 ml of 30% hydrogen peroxide water, and 300 ml of pure water, and stirred for 2 hours. The solution was separated into an aqueous layer of the transition metal catalyst and an organic layer of the resin solution. The aqueous layer was removed. Further, the organic layer was washed with pure water several times. Then, the resin solution was added into methanol, and the precipitated solid content was filtered, and then dried under reduced pressure to remove the solvent, thereby obtaining a polynorbornene.

The polynorbornene obtained above was dissolved in toluene and applied to a carrier film (trade name: “Lumirror film (registered trademark)”, manufactured by Toray Industries, Inc.) to obtain a laminate. The carrier film was removed from the laminate to obtain the resin film of Example 14. In Example 14, the PNB and the COF (a) were kneaded so that the content ratio of the COF (a) was 10 vol % with respect to the entire resin film, and the molten resin composition was applied onto the carrier film so that the thickness of the resin film was 50 μm.

### Examples 15 to 22

Based on Table 1 shown below, resin films were prepared so that at least one of the type of the covalent organic framework (COF) (COF (a), COF (b), COF (c)) and the content ratio (vol %) of the covalent organic framework (COF) with respect to the entire resin film was different from that in Example 14. The resin films of Examples 5 to 12 were prepared in the same manner as in the resin film of Example 14 except for the type and/or content ratio of the COF.

### Example 23

Polymethylpentene (PMP) (trade name: “TPX (registered trademark)”, manufactured by Mitsui Chemicals, Inc.) was melted, and the COF (b) was added to the melted PMP and kneaded with a kneader to obtain a melted resin composition. The molten resin composition was applied onto a continuous metal belt, cooled, and then peeled off from the continuous belt to obtain the resin film of Example 23. In Example 23, the COP and the COF (b) were kneaded so that the content ratio of the COF (b) was 30 vol % with respect to the entire resin film, and the molten resin composition was applied onto a carrier film so that the thickness of the resin film was 50 μm.

### Example 24

The resin film of Example 24 was prepared in the same manner as in the resin film of Example 23 except that the PMP and the COF (b) were kneaded so that the content ratio of the COF (b) was 50 vol % with respect to the entire resin film.

### Comparative Example 1

For Example 1, a resin film was prepared without adding the COF. The other preparation conditions were the same as in Example 1.

### Comparative Example 2

For Example 2, a resin film was prepared without adding the COF. The other preparation conditions were the same as in Example 2.

### Comparative Example 3

For Example 3, a resin film was prepared without adding the COF. The other preparation conditions were the same as in Example 3.

### Comparative Example 4

For Examples 4 to 12, a resin film was prepared without adding the COF. The other preparation conditions were the same as in Examples 4 to 12.

### Comparative Example 5

For Example 13, a resin film was prepared without adding the COF. The other preparation conditions were the same as in Example 13.

### Comparative Example 6

For Examples 14 to 22, a resin film was prepared without adding the COF. The other preparation conditions were the same as in Examples 14 to 22.

### [Measurement of Water Absorption Rate]

The water absorption rate of the resin films of Examples 1 to 24 and Comparative Examples 1 to 6 were measured. Specifically, the mass of the resin film before immersion was measured, each resin film was immersed in water at 20° C. for 24 hours, the moisture on the surface of each resin film was wiped off, and then the water absorption rate of each resin film was measured immediately by the Karl Fischer method. The number “n” of each resin film is 3, and the value described later is the average value thereof.

[Measurement of melting point (Tm)]

The storage elastic modulus (E′) of each of the resin films of Examples 1 to 24 and Comparative Examples 1 to 6 was measured, and the temperature at the inflection point on the high temperature region side of the storage elastic modulus (E′) was defined as the melting point (Tm) of the film. Specifically, the storage elastic modulus (E′) was measured for a test piece (thickness: 50 μm) obtained by cutting the resin film into a width of 9 mm and a length of 40 mm, with a measurement length (measurement jig interval) of 20 mm, by using a dynamic viscoelasticity measuring device (RSA-G2; manufactured by TA-Instruments) under a dry air atmosphere at a temperature rise rate of 3° C./min and −15 to 300° C.

### [Measurement of Relative Permittivity and Dielectric Loss Tangent]

The relative permittivity and dielectric loss tangent of the resin films of Examples 1 to 24 and Comparative Examples 1 to 6 were measured. Specifically, for each resin film, a test piece (thickness: 50 μm) of 30 mm×30 mm was prepared, and the relative permittivity and the dielectric loss tangent of the test piece were measured by a cavity resonator method using a dielectric constant measurement device in accordance with JIS R 1641. The measurement was performed by applying a high-frequency signal of 30 GHz at an ambient temperature of 25° C.

### [Measurement of Linear Expansion Coefficient]

For the resin films of Examples 1 to 24 and Comparative Examples 1 to 6, the linear expansion coefficient (CTE) in the in-plane direction was measured. Specifically, for each resin film, a test piece (thickness: 50 μm) of 200 mm×50 mm was prepared, and the in-plane (XY direction) linear expansion coefficient was measured in accordance with JIS K 7197 by a TMA (thermomechanical analysis) method. As the conditions of TMA, the temperature was raised from room temperature to 150° C. at 10° C./min under a nitrogen atmosphere using a thermal analyzer (TMA4030SA; manufactured by Bruker Corporation), and the load was set to 10 g.

### [Evaluation of Flame Retardancy]

For the resin films of Examples 1 to 24 and

Comparative Examples 1 to 6, a test piece (thickness: 50 μm) of 200 mm×50 mm was prepared in accordance with the UL94 standard, and the test piece was subjected to the vertical burn test for thin films (ASTM D4804) in accordance with the UL standard to perform an evaluation test for determining flame retardancy. In Table 1, a resin film whose flammability classification in the UL standard was VTM-0, VTM-1, or VTM-2 was evaluated as “Flame-retardant”, and a resin film whose sample burned out in the test was evaluated as “No flame-retardant”.

The evaluation results of each resin film of Examples 1 to 24 and Comparative Examples 1 to 6 are shown in Table 1 and Table 2, respectively.

TABLE 1

| | Resin composition | | | | |
|---|---|---|---|---|---|
| | | | COF | Measurement and evaluation | |
| | | | content | Water | Melting |
| | Resin | | ratio | absorption | point Tm |
| | component | COF | [vol %] | rate [mass %] | [° C.] |
| Example 1 | PI | (b) | 30 | 0.9 | >300 |
| Example 2 | SPS | (b) | 30 | 0.12 | 273 |
| Example 3 | LCP | (b) | 30 | 0.04 | >300 |
| Example 4 | PFA | (a) | 10 | <0.01 | >300 |
| Example 5 | PFA | (a) | 30 | <0.01 | >300 |
| Example 6 | PFA | (a) | 50 | <0.01 | >300 |
| Example 7 | PFA | (b) | 10 | <0.01 | >300 |
| Example 8 | PFA | (b) | 30 | <0.01 | >300 |
| Example 9 | PFA | (b) | 50 | <0.01 | >300 |
| Example 10 | PFA | (c) | 10 | <0.01 | >300 |
| Example 11 | PFA | (c) | 30 | <0.01 | >300 |
| Example 12 | PFA | (c) | 50 | <0.01 | >300 |
| Example 13 | COP | (b) | 30 | <0.01 | 269 |
| Example 14 | PNB | (a) | 10 | <0.01 | >300 |
| Example 15 | PNB | (a) | 30 | <0.01 | >300 |
| Example 16 | PNB | (a) | 50 | <0.01 | >300 |
| Example 17 | PNB | (b) | 10 | <0.01 | >300 |
| Example 18 | PNB | (b) | 30 | <0.01 | >300 |
| Example 19 | PNB | (b) | 50 | <0.01 | >300 |
| Example 20 | PNB | (c) | 10 | <0.01 | >300 |
| Example 21 | PNB | (c) | 30 | <0.01 | >300 |
| Example 22 | PNB | (c) | 50 | <0.01 | >300 |
| Example 23 | PMP | (b) | 30 | <0.01 | 233 |
| Example 24 | PMP | (b) | 50 | <0.01 | 233 |

| | Measurement and evaluation | | | |
|---|---|---|---|---|
| | Relative | Dielectric loss | CTE | |
| | permittivity | tangent | [ppm/° C.] | Flame retardancy |
| Example 1 | 3.0 | 0.005 | <20 | Flame-retardant |
| Example 2 | 2.2 | 0.001~0.002 | 51 | Flame-retardant |
| Example 3 | 2.6 | 0.002 | <20 | Flame-retardant |
| Example 4 | 2.1 | 0.008 | 128 | Flame-retardant |
| Example 5 | 2.2 | 0.008 | 109 | Flame-retardant |
| Example 6 | 2.2 | 0.008 | 79 | Flame-retardant |
| Example 7 | 2.1 | <0.001 | 133 | Flame-retardant |
| Example 8 | 2.1 | <0.001 | 107 | Flame-retardant |
| Example 9 | 2.0 | <0.001 | 83 | Flame-retardant |
| Example 10 | 2.1 | <0.001 | 129 | Flame-retardant |
| Example 11 | 2.1 | <0.001 | 113 | Flame-retardant |
| Example 12 | 2.0 | <0.001 | 80 | Flame-retardant |
| Example 13 | 2.2 | <0.001 | 53 | Flame-retardant |
| Example 14 | 2.3 | 0.008 | 48 | Non flame-retardant |
| Example 15 | 2.3 | 0.008 | 41 | Flame-retardant |
| Example 16 | 2.3 | 0.008 | 22 | Flame-retardant |
| Example 17 | 2.3 | <0.001 | 52 | Non flame-retardant |
| Example 18 | 2.2 | <0.001 | 37 | Flame-retardant |
| Example 19 | 2.1 | <0.001 | 20 | Flame-retardant |
| Example 20 | 2.3 | <0.001 | 52 | Non flame-retardant |
| Example 21 | 2.2 | <0.001 | 42 | Flame-retardant |
| Example 22 | 2.1 | <0.001 | 20 | Flame-retardant |
| Example 23 | 2.1 | <0.001 | 35 | Non flame-retardant |
| Example 24 | 2.0 | <0.001 | 29 | Non flame-retardant |

TABLE 2

| | Resin | Measurement and evaluation | | |
|---|---|---|---|---|
| | component | Water | Melting | |
| | (Resin | absorption | point Tm | Relative |
| | composition) | rate [mass %] | [° C.] | permittivity |
| Comparative | PI | 0.9 | >300 | 3.8 |
| Example 1 | | | | |
| Comparative | SPS | 0.12 | 272 | 2.3 |
| Example 2 | | | | |
| Comparative | LCP | 0.04 | >300 | 3.0 |
| Example 3 | | | | |
| Comparative | PFA | <0.01 | >300 | 2.1 |
| Example 4 | | | | |
| Comparative | COP | <0.01 | 266 | 2.3 |
| Example 5 | | | | |
| Comparative | PNB | <0.01 | >300 | 2.3 |
| Example 6 | | | | |

| | Measurement and evaluation | | |
|---|---|---|---|
| | Dielectric loss | CTE | |
| | tangent | [ppm/° C.] | Flame retardancy |
| Comparative | 0.01 | <20 | Flame-retardant |
| Example 1 | | | |
| Comparative | 0.001~0.002 | 70 | Non flame-retardant |
| Example 2 | | | |
| Comparative | 0.002 | <20 | Flame-retardant |
| Example 3 | | | |
| Comparative | <0.001 | 152 | Flame-retardant |
| Example 4 | | | |
| Comparative | <0.001 | 71 | Non flame-retardant |
| Example 5 | | | |
| Comparative | <0.001 | 59 | Non flame-retardant |
| Example 6 | | | |

As shown in Tables 1 and 2, comparing Example 1 and Comparative Example 1, in which the resin components were both polyimide (PI), the resin film of Comparative Example 1 containing no COF had a relatively high relative permittivity of 3.8, but the resin film of Example 1 containing a COF had a relative permittivity of 3.0. The linear expansion coefficient (CTE) of Comparative Example 1 was less than 20 ppm/° C., and that of Example 1 was also less than 20 ppm/° C., both of which were relatively low values.

In addition, comparing Example 2 and Comparative Example 2, in which the resin components were both syndiotactic polystyrene (SPS), the resin film of Comparative Example 2 containing no COF had a relatively high CTE of 70 ppm/° C., but the resin film of Example 2 containing a COF had a CTE of 51 ppm/° C. The relative permittivity of Comparative Example 2 was 2.3, and the relative permittivity of Example 2 was 2.2, both of which were relatively low values.

In addition, when comparing Example 3 and Comparative Example 3, in which the resin components were both liquid crystal polymers, the resin film of Comparative Example 3 containing no COF had a relatively high relative permittivity of 3, but the resin film of Example 3 containing a COF had a relative permittivity of 2.6. The CTEs of both Comparative Example 3 and Example 3 were less than 20 ppm/° C., both of which were relatively low values.

In addition, when comparing Examples 4 to 12 and Comparative Example 4, in which all the resin components were perfluoroalkoxyalkane (PFA), the resin film of Comparative Example 4 containing no COF had a relatively high CTE of 152 ppm/° C., but the resin film of Examples 4 to 12 containing a COF had a CTE of 79 to 133 ppm/° C. The relative permittivity of Comparative Example 4 was 2.1, and the relative permittivity of Examples 4 to 12 were 2.0 to 2.2, all of which were relatively low values.

In addition, when comparing Example 13 and Comparative Example 5, in which the resin components were both a ring-opened polymer of a cyclic olefin-based resin (COP), the resin film of Comparative Example 5 containing no COF had a relatively high CTE of 71 ppm/° C., but the resin film of Example 13 containing a COF had a CTE of 53 ppm/° C. The relative permittivity of Comparative Example 5 was 2.3, and the relative permittivity of Example 13 was 2.2, both of which were relatively low values.

In addition, when comparing Examples 14 to 22 and Comparative Example 6, in which the resin components were all polynorbornene (PNB), the resin film of Comparative Example 6 containing no COF had a relatively high CTE of 59 ppm/° C., but the resin films of Examples 14 to 22 containing a COF had a CTE of 20 to 52 ppm/° C. The relative permittivity of Comparative Example 6 was 2.3, and the relative permittivity of Examples 14 to 22 were 2.1 to 2.3, all of which were relatively low values.

The resin films of Examples 23 and 24, in which the resin components were polymethylpentene (PMP) had relatively low relative permittivities of 2.0 and 2.1, respectively. Furthermore, it is presumed that the resin films of Examples 22 and 23, containing PMP, further contain COF, so that the CTEs were relatively low values of 35 ppm/° C. and 29 ppm/° C., respectively.

As described above, in each example, the COFs had a mesh-like molecular skeleton enclosing air, which has a low relative permittivity. Therefore, when the relative permittivity of the resin component was relatively high, the relative permittivity of the resin composition was lower than that of the resin component. Furthermore, the mesh-like molecular skeleton of the COF was rigid because of having a covalent bond. When the linear expansion coefficient of the resin component was relatively high, the linear expansion coefficient of the resin composition was lower than that of the resin component. Therefore, the resin films of the present Examples can be suitably used for a multilayer substrate.

Furthermore, comparison of the resin films of Examples 4 to 12 shows that when the COF is the COF (b) or the COF (c), that is, when the covalent bond of the COF is a carbon-nitrogen double bond in which the carbon atom of the linker portion and the nitrogen atom of the multi-site core portion are bonded to each other, the resin composition was prevented from having a dielectric loss tangent higher than that of the resin component. The same tendency was obtained in Examples 14 to 22.

Further, comparing the resin films of Examples 14 to 22 and Comparative Example 6, when the content ratio of the COF was 30 vol % or more with respect to the resin composition, the resin composition containing the COF was provided with flame retardancy. The same tendency was obtained in Example 2 and Comparative Example 2, and Example 13 and Comparative Example 5.

In the description of the above embodiment, combinable configurations may be combined with each other.

### [Supplementary Note]

As described above, the present embodiment includes the following disclosure.

<1> A resin film made of a resin composition containing: a resin component; and a covalent organic framework in which a plurality of linker portions and a plurality of multi-site core portions are connected through covalent bonds.

<2> The resin film according to <1>, wherein the resin component is a thermoplastic resin.

<3> The resin film according to <1> or <2>, wherein the resin component has a water absorption rate of 0.1 mass % or less.

<4> The resin film according to any one of <1> to <3>, wherein the resin composition has a melting point of higher than 300° C.

<5> The resin film according to any one of <1> to <4>, wherein the resin composition has a relative permittivity of less than 3.0.

<6> The resin film according to any one of <1> to <5>, wherein the resin composition has a dielectric loss tangent of less than 0.002.

<7> The resin film according to <1>, wherein the resin component is a thermoplastic resin, the resin composition has a water absorption rate of 0.1 mass % or less, the resin composition has a melting point of higher than 300° C., the resin composition has a relative permittivity of less than 3.0, and the resin composition has a dielectric loss tangent of less than 0.002.

<8> The resin film according to any one of <1> to <7>, wherein the resin component is an addition polymer of a norbornene-based monomer.

<9> The resin film according to any one of <1> to <8>, wherein the covalent bond of the covalent organic framework is a carbon-nitrogen double bond.

<10> The resin film according to <9>, wherein terminals of the plurality of linker portions each have a carbon atom; the plurality of multi-site core portions have a nitrogen atom; and the covalent bond of the covalent organic framework is a carbon-nitrogen double bond in which a respective carbon atom of the plurality of linker portions and a respective nitrogen atom of the plurality of multi-site core portions are bonded with each other.

<11> The resin film according to any one of <1> to <10>, wherein the covalent organic framework is contained in a content ratio of 10 vol % to 70 vol % with respect to the resin composition.

The embodiments and examples disclosed herein are all to be considered by way of examples in all respects, but not limiting. The scope of the present invention is specified by the claims, but not the above description, and intended to encompass all modifications within the spirit and scope equivalent to the claims.

The resin film according to the present disclosure can be suitably used as a low dielectric layer included in a multilayer resin substrate (in particular, a circuit board for high frequency) such as a flexible substrate or a rigid substrate.

### DESCRIPTION OF REFERENCE SYMBOLS

1: Resin film
10: Covalent organic framework (COF)
11: Linker portion
12: Multi-site core portion

1. A resin film comprising:
a resin composition containing:
a resin component; and
a covalent organic framework in which a plurality of linker portions and a plurality of multi-site core portions are connected through covalent bonds.

2. The resin film according to claim 1, wherein the resin component is a thermoplastic resin.

3. The resin film according to claim 1, wherein the thermoplastic resin is selected from a cyclic olefin-based resin, a chain olefin-based resin, a fluorine-based resin, a styrene-based resin, and a liquid crystal polymer.

4. The resin film according to claim 1, wherein the resin component has a water absorption rate of 0.1 mass % or less.

5. The resin film according to claim 1, wherein the resin composition has a melting point of higher than 300° C.

6. The resin film according to claim 1, wherein the resin composition has a relative permittivity of less than 3.0.

7. The resin film according to claim 1, wherein the resin composition has a relative permittivity of less than 2.8.

8. The resin film according to claim 1, wherein the resin composition has a relative permittivity of less than 2.6.

9. The resin film according to claim 1, wherein the resin composition has a dielectric loss tangent of less than 0.002.

10. The resin film according to claim 1, wherein the resin composition has a dielectric loss tangent of less than 0.001.

11. The resin film according to claim 1, wherein
the resin component is a thermoplastic resin,
the resin composition has a water absorption rate of 0.1 mass % or less,
the resin composition has a melting point of higher than 300° C.,
the resin composition has a relative permittivity of less than 3.0, and
the resin composition has a dielectric loss tangent of less than 0.002.

12. The resin film according to claim 1, wherein the resin component is an addition polymer of a norbornene-based monomer.

13. The resin film according to claim 1, wherein the covalent bond of the covalent organic framework is a carbon-nitrogen double bond.

14. The resin film according to claim 13, wherein
terminals of the plurality of linker portions each have a carbon atom,
the plurality of multi-site core portions have a nitrogen atom, and
the covalent bond of the covalent organic framework is a carbon-nitrogen double bond in which a respective carbon atom of the plurality linker portions and a respective nitrogen atom of the plurality of multi-site core portions are bonded with each other.

15. The resin film according to claim 1, wherein the covalent organic framework is contained in a content ratio of 10 vol % to 70 vol % with respect to the resin composition.

16. The resin film according to claim 1, wherein the resin component has a linear expansion coefficient in an in-plane direction of less than 59 ppm/° C.

17. The resin film according to claim 1, wherein the covalent organic framework is a porous crystalline particle having a periodic structure.

18. The resin film according to claim 1, wherein the plurality of linker portions and/or the plurality of multi-site core portions have a phosphorus element.

19. The resin film according to claim 1, wherein the plurality of linker portions and/or the plurality of multi-site core portions have an alkyl group.
